(19) United States
(12) Patent Application Publication
(10) Pub. No.: US 2009/0008613 A1
(43) Pub. Date: Jan. 8, 2009

(54) HYBRID POLYISOCYANATES

(75) Inventors: Arno Nennemann, Bergisch-Gladbach (DE); Steffen Hofacker, Odenthal (DE); Markus Mechtel, Bergisch-Glabach (DE); Thomas Klimmasch, Leverkusen (DE); Christopher Guertler, Koeln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/116,523

(22) Filed: May 7, 2008

(30) Foreign Application Priority Data
May 9, 2007 (DE) 102007021630.2

(51) Int. Cl. F21V 9/06

(52) U.S. Cl. 252/589

(57) ABSTRACT

The present invention relates to hybrid organic-inorganic polyisocyanates based on polyfunctional organosilanes, metal alkoxides and alkoxysilane-containing blocked polyisocyanates for the preparation of organic-inorganic coating compositions and adhesives.

### RELATED APPLICATIONS

This application claims benefit to German Patent Application No. 10 2007 021 630.2 filed May 9, 2007, which is incorporated by reference in its entirety for all useful purposes.

### 1. FIELD OF INVENTION

The present invention relates to hybrid organic-inorganic polyisocyanates based on polyfunctional organosilanes, met alkoxides and alkoxysilane-containing blocked polyisocyanates for the preparation of organic-inorganic coating compositions and adhesives.

### 2. BACKGROUND OF THE INVENTION

Attempts are made through the synthesis of organic-inorganic hybrid materials to combine typical properties of organic and inorganic substances in one material. Thus, for example, glasses are distinguished by their great hardness and acid resistance, while organic polymers represent highly elastic materials. Over time, a wide variety of organic-inorganic hybrid materials have become known, which on the one hand are much harder than pure organic polymers and yet do not have the brittleness of purely inorganic materials.

Hybrid materials are classed into different types according to the manner and mode of the interaction between organic and inorganic component. A review of this is found in J. Mater. Chem. 6 (1996) 511.

One class of hybrid materials is obtained by the hydrolysis and condensation of (semi-)metal alkoxy compounds such as Si(OEt)₄, for example, forming an inorganic network which with conventional organic polymers, such as polyesters or polyacrylates, for example, constitutes a mixture whose polymer strands develop a mutual penetration (“interpenetrating network”). There is no covalent chemical attachment of the one network to the other; instead the interactions, if there are any at all, are no more than weak (such as, for example, van der Waals bonds or hydrogen bonds). Hybrid materials of this kind are described for example in WO 93/01226 and WO 98/38251.

WO 98/38251 teaches that transparent hybrid materials are obtainable through mixtures of at least one organic polymer, inorganic particles, an organic-inorganic binder, and solvent. Examples 8-10 describe mixtures which are distinguished as a hybrid coating in their hardness, optical transparency and crack-free application, for example. Of great importance in addition to the properties described therein is—particularly in the field of topcoat coating for the exterior sector—the outdoor weathering stability, in other words the resistance to UV light under simultaneous influence of climatic conditions. This is not satisfactorily solved by the systems described in WO 98/38251. Moreover, no hybrid polyisocyanates are described.

DE 10 2004 048874 discloses hybrid compositions based on an inorganic binder, metal alkoxides, inorganic UV absorbers and an organic polyol. In one example the crosslinking of such systems is carried out with blocked polyisocyanates. In contrast, there is no disclosure or reference to the advantages of polyol-free mixtures of the blocked polyisocyanate with the inorganic components. As compared with existing systems, the systems described in DE 10 2004 048874 do exhibit improved weathering stability and acid resistance, and also higher scratch resistances, but their storage stabilities and also their solvent resistance and chemical resistance are unsatisfactory.

### SUMMARY OF THE INVENTION

It was an object, then, to improve the stability of inorganic, blocked hybrid polyisocyanate compositions containing sol-gel units towards coagulation, and also to improve their performance properties.

Surprisingly it has now been found that this object can be achieved if the blocked polyisocyanates have NCO groups a proportion of which have been reacted with aminoalkoxysilanes.

The present invention provides hybrid polyisocyanate compositions free from organic polyols and comprising

an inorganic binder based on polyfunctional organosilanes which contain at least 2 silicon atoms having in each case 1 to 3 alkoxy or hydroxyl groups, the silicon atoms being attached by in each case at least one Si—C bond to a structural unit linking the silicon unit,

(semi)metal alkoxides and their hydrolysis and condensation products,

ZnO and/or CeO₂ particles as inorganic UV absorbers at least 90% of which have an average particle size as measured by ultracentrifuge of ≦50 nm,

blocked organic polyisocyanates at least a fraction of whose NCO groups have been reacted with isocyanate-reactive alkoxysilanes.

### DETAILED DESCRIPTION OF THE INVENTION

As used herein, the singular terms “a” and “the” are synonymous and used interchangeably with “one or more.” Accordingly, for example, reference to “a substrate” herein or in the appended claims can refer to a single substrate or more than one substrate. Additionally, all numerical values, unless otherwise specifically noted, are understood to be modified by the word “about.”

Inorganic binders of component A) are polyfunctional organosilanes which contain at least 2, preferably at least 3 silicon atoms having in each case 1 to 3 alkoxy or hydroxyl groups, the silicon atoms being attached by in each case at least one Si—C bond to a structural unit linking the silicon atoms.

Examples of linking structural units in the sense of the invention include linear or branched C₁ to C₁₀ alkylene chains, C₅ to C₁₀ cycloalkylene radicals, aromatic radicals, such as phenyl, naphthyl or biphenyl, or else combinations of aromatic and aliphatic radicals. The aliphatic and aromatic radicals may also contain heteroatoms, such as Si, N, O, S or F.

Examples of polyfunctional organosilanes are compounds of the general formula (I)

R¹₄₋ᵢSi[(CH₂)ₙSi(OR²)ₐR³₃₋ₐ]ᵢ (I)

where

i=2, 3 or 4, preferably i=4,

n=1, 2, 3, 4, 5, 6, 7, 8, 9 or 10, preferably n=2 to 4, more preferably n=2

R¹=alkyl or aryl

R²=alkyl or aryl, preferably R²=methyl, ethyl or isopropyl

R³=alkyl or aryl, preferably R³=methyl

a=1, 2 or 3; where a=1 and R² can also denote hydrogen.

Further examples of polyfunctional organosilanes are cyclic compounds of the general formula (II)

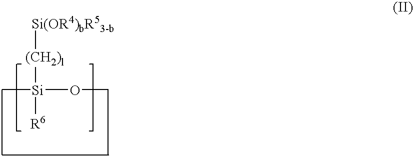

where

m=3, 4, 5 or 6, preferably m=3 or 4

l=2, 3, 4, 5, 6, 7, 8, 9 or 10, preferably l=2

R⁴=alkyl or aryl, preferably R⁴=methyl, ethyl or isopropyl

R⁵=alkyl or aryl, preferably R⁵=methyl

R⁶═C₁-C₆ alkyl or C₆-C₁₄ aryl, preferably R⁶=methyl or ethyl, more preferably R⁶=methyl

b=1, 2 or 3; where b=1 and R⁴ can also denote hydrogen.

Further examples of polyfunctional organosilanes are compounds of the general formula (III)

Si[OSiR⁷₂(CH₂)ₚSi(OR⁸)_{c}R⁹_{3-c}]₄ (III)

where p=1 2, 3, 4, 5, 6, 7, 8, 9 or 10, preferably p=2, 3 or 4, more preferably p=2,

R⁷=alkyl or aryl, preferably R⁷ methyl

R⁸=alkyl or aryl, preferably R⁸=methyl, ethyl or isopropyl

R⁹=alkyl or aryl, preferably R⁹=methyl

c=1, 2 or 3; where c=1 and R⁸ may also denote hydrogen.

Further possible examples of polyfunctional organosilanes, silanols and/or alkoxides include:

Si[(CH₂)₂Si(OH)(CH₃)₂]₄

cyclo-{OSiMe[(CH₂)₂Si(OH)Me₂]}₄

cyclo-{OSiMe[(CH₂)₂Si(OEt)₂Me]}₄

cyclo-{OSiMe[(CH₂)₂Si(OMe)Me₂]}₄

cyclo-{OSiMe[(CH₂)₂Si(OEt)₃]}₄.

It is likewise possible to employ the oligomers, i.e. the hydrolysis and condensation products, of the aforementioned compounds and of compounds of the formulae (I), (II) and/or (III).

With particular preference the inorganic binders of component A) are based on cyclo-{OSiMe[(CH₂)₂Si(OH)Me₂]}₄ and/or cyclo-{OSiMe[(CH₂)₂Si(OEt)₂Me]}₄.

(Semi-)metal alkoxides of component B) conform to the general formula (IV)

R¹⁰_{x-y}M(OR¹¹)_{y} (IV)

where

R¹⁰, R¹¹: are independently of one another alkyl or aryl groups, preferably methyl, ethyl, isopropyl, n-butyl, sec-butyl, tert-butyl or phenyl groups, more preferably methyl or ethyl groups, and

the variables M, x and y are either

M=Si, Sn, Ti or Zr with x=4 and y=1, 2, 3 or 4 or

M=B or Al with x=3 and y=1 to 3.

Examples are Si(OEt)₄, Si(OMe)₄, H₃C—Si(OEt)₃, H₃C—Si(OMe)₃, B(OEt)₃, Al(OⁱPr)₃, or Zr(OⁱPr)₄. In the sense of the invention it is also possible, instead of the monomeric alkoxides, to use their hydrolysis and condensation products. Available commercially, for example, are Si(OEt)₄condensates.

Particular preference is given to using in component B) Si(OEt)₄ and its hydrolysis and/or condensation products.

The inorganic UV absorbers of component C) preferably have an average particle size of ≦30 nm.

Preferably at least 98%, with particular preference at least 99.5%, of all the particles used have the required average particle size.

These inorganic UV absorbers may be used not only in solid form but preferably in the form of dispersions (sols). Solvents which can be used in this case include not only water, aqueous acids or bases but also organic solvents or mixtures thereof.

Particular preference is given to using in C) dispersions (sols) of ZnO and/or CeO₂, with very particular preference acid-stabilized dispersions (sols) of CeO₂ of the aforementioned size ranges.

The blocked polyisocyanates of component D) are based on the NCO-functional compounds, known per se to the skilled person, that have more than one NCO group per molecule. These compounds preferably have NCO functionalities of 2.3 to 4.5, NCO group contents of 11.0% to 24.0% by weight and monomeric diisocyanate contents of less than 1% by weight, preferably less than 0.5% by weight.

Polyisocyanates of this kind are obtainable by modifying simple aliphatic, cycloaliphatic, araliphatic and/or aromatic diisocyanates and may have uretdione, isocyanurate, allophanate, biuret, iminooxadiazinedione and/or oxadiazinetrione structures. Additionally it is possible to use such polyisocyanates as NCO-containing prepolymers. Polyisocyanates of this kind are described for example in Laas et al. (1994), J. prakt, Chem. 336, 185-200 or in Bock (1999), Polyurethane für Lacke und Beschichtungen, Vincentz Verlag, Hannover, pp. 21-27.

Suitable diisocyanates for preparing such polyisocyanates are any desired diisocyanates, obtainable through phosgenation or by phosgene-free methods, as for example by thermal urethane cleavage, of the molecular weight range 140 to 400 g/mol containing aliphatically, cycloaliphatically, araliphatically and/or aromatically attached isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diissocyanate, (IPDI)), 4,4′-diisocyanatodicyclohexylmethane, 1-isocyanato-1-methyl-4(3)-isocyanatomethylcyclohexane, bis(isocyanatomethyl)norbornane, 1,3- and 1,4-bis(1-isocyanato-1-methylethyl)benzene (TMXDI), 2,4- and 2,6-diisocyanatotoluene (TDI), 2,4′- and 4,4′-diisocyanatodiphenylmethane (MDI), 1,5-diisocyanatonaphthalene or any desired mixtures of such diisocyanates.

The blocked polyisocyanates of component D) are based preferably on IPDI, MDI, TDI, 4,4′-diisocyanatodicyclohexylmethane, HDI and mixtures thereof. With particular preference they are based on IPDI and/or HDI.

The blocked polyisocyanates of component D) are typically obtainable by reacting polyisocyanates of the aforementioned kind with aminoalkoxysilanes and then subsequently reacting the remaining free NCO groups with blocking agents that are known per se to the skilled person (Houben Weyl, Methoden der organischen Chemie XIV/2, pp. 61-70).

Isocyanate-reactive alkoxysilanes used are preferably compounds of the formula (V)

Q-Z-SiXₐY₃₋ₐ (V)

where

Q is an isocyanate-reactive group,

X is a hydrolysable group,

Y is identical or different alkyl groups

Z is a C₁-C₁₂-alkylene group and

a is an integer from 1 to 3.

Preferably in formula (V) the group Q is a group which is reactive towards isocyanate groups with formation of urethane, urea or thiourea. Such groups are preferably OH groups, SH groups or primary or secondary amino groups.

Preferred amino groups conform to the formula —NHR¹, where R¹ is hydrogen, a C₁-C₁₂ alkyl group or C₆-C₂₀ aryl group,

Preferably in formula (I) the group X is an alkoxy or hydroxyl group, with particular preference methoxy, ethoxy, propoxy or butoxy.

Preferably Y in formula (I) stands for a linear or branched C₁-C₄ alkyl group, preferably methyl or ethyl.

Z in formula (V) is preferably a linear or branched C₁-C₄ alkylene group.

Preferably a in formula (V) stands for 1 or 2.

Suitable alkoxysilanes of the formula (V) are hydroxymethyltri(m)ethoxysilane, 3-mercaptopropyltrimethoxysilane, 3-inercaptopropyltriethoxysilane, 3-aminopropyl-tri(m)ethoxysilane, 3-aminopropylmethyldi(m)ethoxysilane and alkoxysilyl compounds having secondary amino groups. Examples of such secondary aminoalkoxysilanes are N-methyl-3-aminopropyltri(m)ethoxysilane, N-phenyl-3-aminopropyltrimethoxysilane, Bis(gamma-trimethoxysilylpropyl)amine, N-butyl-3-aminopropyltri(m)ethoxysilane, N-ethyl-3-aminoisobutyltri(m)ethoxysilane or N-ethyl-3-aminoisobutylmethyldi(m)ethoxysilane and also the analogous C₂-C₄ alkoxysilanes.

Likewise preferred isocyanate-reactive alkoxysilanes are aspartic esters, of the kind obtained, for example, in accordance with U.S. Pat. No. 5,364,955 through the reaction of aminosilanes with maleic or fumaric esters, preferably dimethyl maleate or diethyl maleate.

Particularly preferred isocyanate-reactive alkoxysilanes for modifying the polyisocyanates are secondary aminoalkoxysilanes of the type described above, with particular preference aspartic esters and aminoalkoxysilanes having one or two alkoxy groups.

The aforementioned alkoxysilanes can be used individually or else in mixtures with a modification.

In the modification the ratio of free NCO groups of the isocyanate to be modified to the NCO-reactive groups Q of the alkoxysilane of the formula (V) is preferably 1:0.01 to 1:0.75, with particular preference 1:0.05 to 1:0.4.

In principle of course it is also possible to modify higher fractions of NCO groups with the aforementioned alkoxysilanes; however, it should be ensured that the number of free NCO groups available for crosslinking is still sufficient for satisfactory crosslinking.

For the blocking, the isocyanates to be blocked, modified as above, are reacted with one or with a mixture of two or more blocking agents.

Suitable blocking agents include all compounds which when the blocked (poly)isocyanate is heated can be eliminated, where appropriate with the presence of a catalyst. Suitable blocking agents are, for example, sterically bulky amines such as dicyclohexylamine, diisopropylamine, N-tert-butyl-N-benzylamine, caprolactam, butanone oxime, imidazoles with the various conceivable substitution patterns, pyrazoles such as 3,5-dimethylpyrazole, triazoles and tetrazoles, and also alcohols such as isopropanol, ethanol, methyl ethyl ketoxime, malonic esters.

Besides this there is also the possibility of blocking the isocyanate group in such a way that in the event of an ongoing reaction the blocking agent is not eliminated but instead the intermediate formed intermediately is consumed by reaction. This is the case in particular with cyclopentanone-2-carboxyethyl ester, which in the thermal crosslinking reaction is incorporated fully by reaction into the polymeric network and is not eliminated again.

Preferred blocking agents are butanone oxime, caprolactam, malonic esters, diisopropylamine, cyclopentanone-2-carboxyethyl ester, cyclopentanone-2-carboxymethyl ester, isopropanol, dimethylpyrazole and mixtures thereof. Particular preference is given to dimethylpyrazole.

The free NCO group content of the polyisocyanates of the invention of component D) is <5% by weight, preferably <0.5% by weight, more particularly <0.1% by weight.

To adjust the viscosity of the hybrid polyisocyanate compositions of the invention it is also possible, in addition to components A) to D), to add organic solvents. Examples are alcohols, such as methanol, ethanol, isopropanol, 2-butanol, 1,2-ethanediol or glycerol, ketones, such as acetone, methyl ethyl ketone, methyl isobutyl ketone or butanone, esters, such as ethyl acetate or methoxypropyl acetate, aromatics, such as toluene or xylene, ethers, such as tert-butyl methyl ether, and aliphatic hydrocarbons.

Preference is given to polar solvents and particular preference to using alcohols of the aforementioned kind.

Particular preference is given to using solvent mixtures with alcohol and/or ester fractions of more than 50% by weight, with particular preference of more than 80% by weight.

The amount of the solvents is preferably chosen such that the solids content of the composition lies 5% to 75% by weight, with particular preference 20% to 55% by weight.

The hybrid polyisocyanate compositions of the invention may, furthermore, also comprise catalysts which serve to accelerate the hydrolysis and condensation reactions. Catalysts which can be used include organic and inorganic acids and bases and also organometallic compounds, fluoride compounds or else metal alkoxides. Examples that may be mentioned include the following: acetic acid, p-toluenesulphonic acid, hydrochloric acid, sulphuric acid, ammonia, dibutylamine, potassium hydroxide, sodium hydroxide, ammonium fluoride, sodium fluoride, or aluminium isopropoxide.

In one preferred embodiment of the invention the hybrid polyisocyanate compositions of the invention, based on components A) to D), have a composition of

1% to 40% by weight of inorganic binder A),

10% to 80% by weight of (semi-)metal alkoxides B),

0.1% to 20% by weight of inorganic UV absorbers C) and

5% to 70% by weight of alkoxysilane-modified and blocked polyisocyanate D),

the ingredients A) to D) adding up to 100% by weight.

In one particularly preferred embodiment of the invention the hybrid polyisocyanate compositions of the invention, based on components A) to D), have a composition of

5% to 30% by weight of inorganic binder A),

20% to 65% by weight of (semi-)metal alkoxides B),

0.2% to 10% by weight of inorganic UV absorbers C) and

10% to 50% by weight of alkoxysilane-modified and blocked polyisocyanate D),

the ingredients A) to D) adding up to 100% by weight.

The hybrid polyisocyanate compositions of the invention are typically prepared by first introducing components A) and B) and also, where appropriate, fractions of organic solvent and then, where appropriate, carrying out (partial) hydrolysis by addition of acid, and finally adding component C) and, where appropriate, further organic solvents with stirring and, where appropriate, with cooling. The is followed by the addition of component D).

In this case the inorganic UV absorbers C) are incorporated into the composition of the invention preferably by stirred incorporation into component A) and/or B) of the invention. Stirred incorporation into the organic polyisocyanate component is not preferred.

The present invention further provides coating compositions at least comprising

one of the above-described hybrid polyisocyanate compositions and also

at least one polyol or polyamine.

Besides the hybrid polyisocyanate compositions the polyurethane systems of the present invention comprise polyhydroxy compounds and/or polyamine compounds for crosslinking. Besides these there may also be other polyisocyanates, different from the polyisocyanates of the invention, and also auxiliaries and additives present.

Examples of suitable polyhydroxyl compounds are trifunctional and/or tetrafunctional alcohols and/or the polyether polyols, polyester polyols and/or polyacrylate polyols that are typical per se in coatings technology.

Furthermore, for the crosslinking, it is also possible to use polyurethanes or polyureas which are crosslinkable with polyisocyanates by virtue of the active hydrogen atoms present in the urethane or urea groups respectively.

Likewise possible is the use of polyamines, whose amino groups may have been blocked, such as polyketimines, polyaldimines or oxazolanes.

For the crosslinking of the polyisocyanates of the invention it is preferred to use polyacrylate polyols and polyester polyols.

As catalysts for the reaction of the compositions of the invention with the polyisocyanates it is possible to use catalysts such as commercially customary organometallic compounds of the elements aluminium, tin, zinc, titanium, manganese, iron, bismuth or else zirconium such as, for example, dibutyltin laurate, zinc octoate, titanium tetraisopropoxide. Suitability is furthermore also possessed, however, by tertiary amines such as 1,4-diazabicyclo[2.2.2]octane, for example.

A further possibility is to accelerate the reaction of the polyols and/or polyamines from b) with the compositions of the invention from a) by carrying out this reaction at temperatures between 20 and 200° C., preferably between 60 and 180° C., with particular preference between 70 and 150° C.

The ratio of a) to b) is set such as to result in an NCO/OH ratio of the free and, where appropriate, blocked NCO groups of a) to the OH groups of component b) of 0.3 to 2, preferably 0.4 to 1.5, with particular preference 0.5 to 1.0.

In blends with the auxiliaries that are typical in coatings technology, such as organic or inorganic pigments, further organic light stabilizers, free-radical scavengers, coatings additives, such as dispersing, flow-control, thickening, defoaming and other auxiliaries, adhesives, fungicides, bactericides, stabilizers or inhibitors and further catalysts, it is possible, from the composition of the invention, more particularly in the form of the coating compositions of the invention, to produce highly resistant coatings for carmaking.

Furthermore, the coating compositions of the invention may also find application in the fields of coating plastics, coating floors and/or coating wood/furniture.

### EXAMPLES

All percentages, unless indicated otherwise, refer to percent by weight.

Cyclo-{OSiMe[(CH₂)₂Si(OEt)₂Me]}₄ (D4 diethoxide) was prepared as described in Example 2 in WO 98/38251.

Desmodur® VPLS 2253: 3,5-dimethylpyrazole-blocked polyisocyanate (trimer) based on HDI; 75% in MPA/SN 100 (8:17), viscosity at 23° C. about 3600 mPas, blocked NCO content 10.5%, equivalent weight 400, Bayer MaterialScience AG, Leverkusen, Del.

Desmodur® N3300: hexamethylene diisocyanate trimer; NCO content 21.8+/−0.3% by weight, viscosity at 23° C. about 3000 mPas, Bayer MaterialScience AG, Leverkusen, Del.

Desmophen A665 BA: polyacrylate polyol, 70% in butyl acetate, OH content 3.2%, viscosity at 23° C. about 8500 mPas, commercial product of Bayer MaterialScience AG, Leverkusen, Del.

Baysilone® coatings additive OL 17: flow control assistant, 100% as-supplied form (Borchers GmbH, Langenfeld, Germany)

BYK® 070: defoamer, 10% strength in MPA/BA/xylene as-supplied form. (BYK-Chemie GmbH, Wesel, Germany)

Tinuvin® 123: free-radical scavenger, 100% as-supplied form (Ciba Spezialitätenchemie Lampertheim GmbH, Lampertheim, Germany)

Tinuvin® 384-2: UV stabilizer, 100% as-supplied form (Ciba Spezialitätenchemie Lampertheim GmbH, Lampertheim, Germany)

MPA/SN mixture: 1:1 mixture of 1-methoxypropyl acetate and solvent naphtha 100 (Kraemer&Martin GmbH, St. Augustin, Germany)

DBTL: >97% as-supplied form (dibutyltin dilaurate, Brenntag AG, Mülheim/R., Germany)

Chemical resistance according to DIN EN ISO 2812-5 “Coating materials—determination of resistance to liquids—Part 5. Method with the gradient oven”. The chemicals is reported in ° C. units. For this purpose, 1% strength sulphuric acid or the corresponding chemicals are sprinkled onto the coating, which is then heated in a gradient oven. The temperature at which visible damage to the coating first occurs is reported in Table 1. The higher this temperature, the more resistant the coating is to the chemical in question.

Scratch resistance, laboratory wash unit (wet scratching) according to DIN EN ISO 20566 “Coating materials—testing of the scratch resistance of a coating system using a laboratory wash unit”. The relative residual gloss in % indicates the level of the gloss [20°] after scratching in accordance with DIN 5668 in comparison to the gloss before scratching. The higher this figure, the better the scratch resistance. The initial gloss prior to scratching was between 87% and 92% for all of the systems.

Determination of solvent resistance This test was used to ascertain the resistance of a cured coating film to various solvents. For this purpose the surface of the coating is exposed to the solvents for a defined time. Subsequently an assessment is made, both visually and by touch with the hand, as to whether and, if so, what changes have occurred on the area under test. The coating film is generally situated on a glass plate; other substrates are likewise possible. The test tube stand with the solvents xylene, 1-methoxyprop-2-yl acetate, ethyl acetate and acetone (see below) is placed on the surface of the coating in such a way that the openings of the test tubes with the cotton-wool plugs are lying on the film. The important factor is the resultant wetting of the surface of the coating by the solvent. After the defined exposure time to the solvents, of 1 minute and 5 minutes, the test tube stand is removed from the surface of the coating. Subsequently the solvent residues are immediately removed by means of an absorbent paper or textile fabric. After cautious scratching with the fingernail, the area under test is then immediately rated visually for changes. The following gradations are differentiated:

0=unchanged

1=trace changed e.g. only visible change

2=slightly changed e.g. softening perceptible with the fingernail can be found

3=markedly changed e.g. severe softening can be found with the fingernail

4=severely changed e.g. with the fingernail down to the substrate

5=destroyed e.g. coating surface destroyed without external action.

The evaluation gradations found for the solvents indicated above are documented in the following sequence:

Example 0000 (no change)

Example 0001 (visible change only for acetone)

The numerical sequence here describes the sequence of solvents tested (xylene, methoxypropyl acetate, ethyl acetate, acetone)

Storage stability: To determine the storage stability, the specimens were stored at corresponding temperatures and were regularly inspected for gelling, sedimentation and discoloration.

### Example 1

N-(3-Trimethoxysilylpropyl)aspartic acid diethyl ester was prepared, in accordance with the teaching from U.S. Pat. No. 5,364,955, Example 5, by reacting equimolar amounts of 3-aminopropyltrimethoxysilane with diethyl maleate.

### Example 2

### Preparation of the Precursor of the Inventive Composition (Inorganic Precondensate)

Drawing on DE102004048874 A1, Example 1, a 4 l multi-neck flask was charged with 204.7 g of D4 diethoxide, 1054.1 g of tetraethoxysilane, 309.7 g of ethanol, 929.2 g of 2-butanol and 103.3 g of butyl glycol, this initial charge was homogenized, and then to start with 108.4 g of 0.1 molar hydrochloric acid were added with stirring. After a stirring time of 30 minutes a further 111.2 g of 0.1 molar hydrochloric acid were added with stirring, followed by stirring for 60 minutes more. Thereafter 56.8 g of cerium dioxide particles (Cerium Colloidal 20%, Rhodia GmbH, Frankfurt/Main, Germany) were added with stirring, and subsequently 55.1 g of 2.5% strength acetic acid were added. After 24 hours of ageing, the inorganic precondensate was processed further. The solids was 20.78% and was concentrated where appropriate by removal of low-boiling components (at 80 mbar and 40° C. water bath temperature on a rotary evaporator under vacuum).

### Example 3

### Preparation of an Inventive Composition

A standard stirring apparatus was charged with 192.7 g (1 eq) of Desmodur® N3300 (hexamethylene diisocyanate trimer; NCO content 21.8+/−0.3% by weight, viscosity at 23° C. about 3000 mPas, Bayer MaterialScience AG, Leverkusen, Del.) in 85 g of butyl acetate at 60° C. Then, with caution, 70.3 g (0.2 eq) of the alkoxysilane from Example 1 were added dropwise, the temperature being held to a maximum of 60° C. After the end of the reaction (checking of the NCO content by IR spectroscopy for constancy) the product was cooled to RT and, with caution, 76.9 g of 1,3-dimethylpyrazole (DMP) were added and the temperature was held at 50° C. until the NCO peak within the IR spectrometer had disappeared.

The product was a colourless, liquid, blocked polyisocyanate having the following characteristics: solids content 80% by weight, viscosity 3440 mPas at 23° C., and 7.91% blocked NCO content based on DMP.

### Example 4

### Inventive

133.4 g of the compound from Example 3 were mixed with 366.7 g of the compound from Example 2 and the mixture was homogenized and then filtered through a 10 μm filter. The resulting mixture had a theoretical solids of 43.3% in 2-butanol/ethanol/butyl acetate, a theoretical blocked NCO content of 2.1% and an equivalent weight of 1991.

The mixture was translucent/yellowish and at room temperature for about 2 weeks was sedimentation-free and homogeneous.

### Example 5

A standard stirring apparatus was charged with 481 g (1 eq) of Desmodur® N3300 (hexamethylene diisocyanate trimer; NCO content 21.8+/−0.3% by weight, viscosity at 23° C. about 3000 mPas, Bayer MaterialScience AG, Leverkusen, Del.) in 228.4 g of butyl acetate at 60° C. Then, with caution, 263.6 g (0.3 eq) of the alkoxysilane from Example 1 were added dropwise, the temperature being held to a maximum of 60° C. After the end of the reaction (checking of the NCO content by IR spectroscopy for constancy) the product was cooled to RT and, with caution, 168.2 g of 1,3-dimethylpyrazole (DMP) were added and the temperature was held at 50° C. until the NCO peak within the IR spectrometer had disappeared.

The product was a colourless, liquid, blocked polyisocyanate having the following characteristics: solids content 80% by weight, viscosity 2450 mPas at 23° C., equivalent weight 652.6 g/eq, and 6.44% blocked NCO content based on DMP.

### Example 6

198.4 g of the compound from Example 5 were mixed with 501.6 g of the compound from Example 2 and the mixture was homogenized and then filtered through a 10 μm filter. The resulting mixture had a solids of 40.1% in 2-butanol/ethanol/butyl acetate, a theoretical blocked NCO content of 1.66% and an equivalent weight of 566.7.

The mixture was transparent/yellowish and at room temperature for about 10 days was stable to gelling and sedimentation-free.

### Example 7

### Comparative Example to Example 4 and 6

24.9 g of Desmodur® VPLS 2253 (3,5-dimethylpyrazole-blocked polyisocyanate (trimer) based on HDI; 75% in MPA/SN 100 (8:17), viscosity at 23° C. about 3600 mPas, blocked NCO content 10.5%, equivalent weight 400, Bayer MaterialScience AG, Leverkusen, Del.) were mixed with 75.1 g of the compound from Example 2 and the mixture was homogenized and then filtered through a 10 μm filter. The resulting mixture had a theoretical solids of 40.7% in 2-butanol/ethanol/MPA/SN100 and a theoretical blocked NCO content of 2.6%.

The mixture underwent severe clouding and showed phase separation.

### Example 8

A standard stirring apparatus was charged with 192.7 g (1 eq) of Desmodur® N3300 (hexamethylene diisocyanate trimer; NCO content 21.8+/−0.3% by weight, viscosity at 23° C. about 3000 mPas, Bayer MaterialScience AG, Leverkusen, Del.) in 94.2 g of butyl acetate at 60° C. Then, with caution, 70.38 g (0.2 eq) of the alkoxysilane from Example 1 were added dropwise, the temperature being held to a maximum of 60° C. After the end of the reaction (checking of the NCO content by IR spectroscopy for constancy) the product was cooled to RT and, with caution, 113.8 g of cyclopentanecarboxymethyl ester (CPME) were added and the temperature was held at 50° C. until the NCO peak within the IR spectrometer had disappeared.

The product was a colourless, liquid, blocked polyisocyanate having the following characteristics: solids content 80% by weight, viscosity 2380 mPas at 23° C., and 7.13% blocked NCO content based on CPME.

### Example 9

13.8 g of the compound from Example 7 were mixed with 36.2 g of the compound from Example 2 and the mixture was homogenized and then filtered through a 10 μm filter. The resulting mixture had a theoretical solids of 43.8% in 2-butanol/ethanol/butyl acetate and a theoretical blocked NCO content of 1.97%.

The mixture was transparent/yellowish and at room temperature for about 30 days was stable to gelling and sedimentation-free.

### Example 10

### Comparative Example, Non-Blocked Polyisocyanate

17.5 g of Desmodur® N3300 (hexamethylene diisocyanate trimer; NCO content 21.8+/−0.3% by weight, viscosity at 23° C. about 3000 mPas, Bayer MaterialScience AG, Leverkusen, Del.) were mixed with 82.5 g of the compound from Example 2 and the mixture was homogenized and then filtered through a 10 μm filter. The resulting mixture had a theoretical solids of 40% in 2-butanol/ethanol/butyl acetate and a theoretical NCO content of 3.43%.

The mixture was cloudy and separated into two phases.

Performance Testing

In Example 11 the inventive hybrid polyisocyanate from Example 4 was rendered as per Table 1 with Desmophen® A665 BA/X in an NCO/OH ratio of 1/1 and with coatings additives, and the ingredients were stirred together thoroughly. The solids of the hybrid coating material was approximately 30% and was adjusted where appropriate with a 1:1 MPA/SN solvent mixture.

Before processing, the coating material was deaerated for 10 minutes. The coating material was then applied using a gravity-feed cup-type gun in 1.5 cross-passes to the prepared substrate (3.0-3.5 bar compressed air, nozzle: 1.4-1.5 mm Ø, nozzle-substrate spacing: about 20-30 cm). After a flash-off time of 15 minutes the coating was baked at 140° C. for 30 minutes. The dry film thickness was in each case about 30 μm. After conditioning/ageing at 60° C. for 16 hours, paint testing was commenced. The results are compiled in Table 2.

For the purpose of comparison, a conventional coating system comprising Desmophen® A665 BA/X and Desmodur® BL 2253 (Example 12) and also coatings additives (Table 1) was formulated and applied analogously. The standard 1K PU clearcoat had a solids of approximately 48%, which where appropriate was adjusted using a 1:1 MPA/SN solvent mixture. The results are likewise summarized in Table 2.

Table 1. Amounts Employed, Additives

Hybrid Coating Materials:

0.2% Baysilone OL 17 (solids/binder solids), used as a 10% strength solution in MPA

2.0% Byk 070 (as-supplied form/binder solids), used in as-supplied form (10% strength solution)

1.0% Tinuvin 123 (solids/binder solids), used in as-supplied form (100%)

1.5% Tinuvin 384-2 (solids/binder solids) used in as-supplied form (100%)

About 0.5% DBTL (solids/solids), used as a 10% strength solution in MPA

Standard 1K PU Coating Materials:

0.1% Baysilone OL 17 (solids/binder solids), used as a 10% strength solution in MPA

0.01% Modaflow (solids/binder solids), used 1% in MPA

1.0% Tinuvin 292 (solids/binder solids), used as a 10% strength solution in MPA

1.5% Tinuvin 384-2 (solids/binder solids), used as a 10% strength solution in MPA

About 0.5% DBTL (solids/solids), used as a 10% strength solution in MPA

TABLE 2
Comparison of paint-technology properties

| | Example 11 | Example 12 |
|---|---|---|
| Example | inventive | comparative |
| NCO/OH | 1 | 1 |
| Solvent resistance | 0022 | 2244 |
| (X/MPA/EA/Ac) | | |
| [rating]¹⁾ | | |
| after 5 min. | | |
| Chemical resistance | | |
| (gradient oven) [° C.] | | |
| Tree resin | 60 | 36 |
| H₂SO₄, 1% | 49 | 43 |
| FAM, 10 min [rating]¹⁾ | 0 | 2 |
| Scratch resistance | | |
| (Amtec Kistler | | |
| laboratory wash unit) | | |
| Relative residual | 89.4 | 76.8 |
| gloss [%] | | |
| Deblocking | | |
| temperature [° C.] | | |
| Without DBTL | 76 | 144 |
| With DBTL | 78 | 128 |

As well as its colloidal stability and hence formability, Inventive Example 11 shows distinctly improved chemical resistance and solvent resistance, and also an increased scratch resistance as compared with the non-hybrid, blocked polyisocyanate (Example 12). Furthermore, it was possible to carry out the crosslinking at significantly lower temperatures.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

1. A hybrid polyisocyanate composition free from organic polyols comprising
A) an inorganic binder based on polyfunctional organosilanes which contain at least 2 silicon atoms having in each case 1 to 3 alkoxy or hydroxyl groups, the silicon atoms being attached by in each case at least one Si—C bond to a structural unit linking the silicon unit,
B) (semi-)metal alkoxides and their hydrolysis and condensation products,
C) ZnO and/or CeO₂ particles as inorganic UV absorbers at least 90% of which have an average particle size as measured by ultracentrifuge of ≦50 nm, and
D) blocked organic polyisocyanates at least a fraction of whose NCO groups have been reacted with isocyanate-reactive alkoxysilanes.

2. The hybrid polyisocyanate composition according to claim 1, wherein the inorganic binders of component A) are based on cyclo-{OSiMe[(CH₂)₂Si(OH)Me₂]}₄ or cyclo-{OSiMe[(CH₂)₂Si(OEt)₂Me]}₄ or a mixture thereof.

3. The hybrid polyisocyanate composition according to claim 1, wherein component B) is Si(OEt)₄ and/or its hydrolysis and/or condensation products.

4. The hybrid polyisocyanate composition according to claim 1, wherein at least 99.5% of the inorganic UV absorbers of component C) have an average particle size of ≦30 nm.

5. The hybrid polyisocyanate composition according to claim 1, wherein the inorganic UV absorbers of component C) are used in the form of dispersions or sols.

6. The hybrid polyisocyanate composition according to claim 1, wherein said inorganic UV absorbers are acid-stabilized dispersions (sols) of CeO₂.

7. The hybrid polyisocyanate composition according to claim 1, wherein the blocked polyisocyanates used in D) have NCO functionalities of 2.3 to 4.5, NCO group contents of 11.0% to 24.0% by weight and monomeric diisocyanate contents of less than 1% by weight.

8. The hybrid polyisocyanate composition according to claim 1, wherein the blocked polyisocyanates used in D) are based on isophorone diisocyanate (IPDI), 2,4′-diisocyanatodiphenylmethane, 4,4′-diisocyanatodiphenylmethane (MDI), 2,4-diisocyanatotoluene, 2,6-diisocyanatotoluene (TDI), 4,4′-diisocyanatodicyclohexylmethane, 1,6-diisocyanatohexane (HDI) or mixtures thereof.

9. The hybrid polyisocyanate composition according to claim 1, wherein the alkoxysilyl-containing blocked polyisocyanates used in D) are prepared starting from a polyisocyanate whose free NCO groups are then reacted with aminoalkoxysilanes and subsequently the remaining free NCO groups are blocked with a blocking agent.

10. The hybrid polyisocyanate composition according to claim 9, wherein said aminoalkoxysilanes are N-(trimethoxysilylpropyl)aspartic acid diethyl esters.

11. The hybrid polyisocyanate composition according to claim 1, wherein the NCO groups of the blocked polyisocyanates used in D) are blocked with butanone oxime, caprolactam, malonic esters, diisopropylamine, cyclopentanone-2-carboxyethyl(methyl) ester, isopropanol or mixtures thereof.

12. The hybrid polyisocyanate composition according to claim 2, wherein component B) is Si(OEt)₄ and/or its hydrolysis and/or condensation products.

13. The hybrid polyisocyanate composition according to claim 12, wherein at least 99.5% of the inorganic UV absorbers of component C) have an average particle size of ≦30 nm.

14. The hybrid polyisocyanate composition according to claim 13, wherein said inorganic UV absorbers are acid-stabilized dispersions (sols) of CeO₂.

15. The hybrid polyisocyanate composition according to claim 14, wherein the blocked polyisocyanates used in D) have NCO functionalities of 2.3 to 4.5, NCO group contents of 11.0% to 24.0% by weight and monomeric diisocyanate contents of less than 1% by weight.

16. The hybrid polyisocyanate composition according to claim 15, wherein the NCO groups of the blocked polyisocyanates used in D) are blocked with butanone oxime, caprolactam, malonic esters, diisopropylamine, cyclopentanone-2-carboxyethyl(methyl) ester, isopropanol or mixtures thereof.

17. A coating composition comprising
a) the hybrid polyisocyanate composition according to claim 1 and
b) at least one polyol or polyamine.

18. A method of coating a substrate which comprises applying to a substrate a mixture of
a) the hybrid polyisocyanate composition according to claim 1 with
b) at least one polyol or polyamine.

19. A substrate coated with the coating composition according to claim 17.
